(19) United States
(12) Patent Application Publication
(10) Pub. No.: US 2003/0113602 A1
(43) Pub. Date: Jun. 19, 2003

(54) Fuel preparation unit and method for preparing a fuel that contains hydrogen

(76) Inventors: Michael Nau, Dornhan/ Aischfeld (DE); Horst Harndorf, Schauenburg (DE); Rainer Saliger, Freiberg (DE); Jens Intorp, Aachen (DE)

Correspondence Address: STRIKER, STRIKER & STENBY, 103 East Neck Road, Huntington, NY, 11743, US

(21) Appl. No.: 10/288,687

(22) Filed: Nov. 6, 2002

(30) Foreign Application Priority Data
Nov. 7, 2001 (DE) 101 54 637.8-41

(51) Int. Cl. H01M 8/04; F23D 14/28; H01M 8/06

(52) U.S. Cl. 429/25; 431/344; 429/17; 429/19; 429/20; 422/198; 180/68.5

(57) ABSTRACT

A fuel preparation unit and a method for furnishing a fuel that contains hydrogen to a fuel energy converter (12) for chemical conversion and energy conversion of the fuel includes a fuel pressure reservoir (2) for storing the fuel subjected to pressure, with which the efficiency of furnishing the fuel is improved. At least one separate pressure energy recycling unit (4, 8, 9) for converting and recycling pressure energy of the fuel is utilized.

### BACKGROUND OF THE INVENTION

The present invention relates to a fuel preparation unit and a method for furnishing a fuel that contains hydrogen to a fuel energy converter for chemical conversion and energy conversion of the fuel.

Interest in hydrogen as an energy carrier for the future has been increasing in the last few years. For all fuel cells operating with hydrogen, environmentally protective energy and heat can be produced. The efficiency of fuel cells is not limited by the Carnot process. With correspondingly high efficiency, for example, fossil resources can be conserved, and can be reduced with the use of fuel cells in motor vehicles or power-heat coupling assemblies.

With fuel cells, the chemically latent energy of the hydrogen is converted directly into electrical energy, which, for example, can be transferred into mechanical, motive energy in motor vehicle use with the assistance of an electric motor.

In addition, modern motor vehicles, in increasing numbers, are being equipped with a plurality of electrical consuming devices, in order to offer additional functions for improvement of the engine control, or the comfort and/or safety of the passengers. The increased electrical energy requirements related to these devices can be covered by means of a corresponding fuel cell in combination with the combustion engine, or its so-called light machine.

In particular, for motor vehicle use, other, so-called PEM fuel cells (polymer-electrolyte-membrane fuel cells) are used, with which proton-conducting polymer membranes are used and the purest hydrogen available is required as fuel.

Further, hydrogen can be chemically converted in combustion engines, in particular in hoist engines, for producing mechanical motive energy.

Principally, hydrogen offers the possibility of a regenerative preparation, as well as carbon dioxide free and related contaminant free combustion or conversion.

Above all, with motor vehicle use or other island systems, the hydrogen or the hydrogen-containing fuel is stored in pressure tanks. At the present time, corresponding pressure containers are equipped for storage pressures of approximately 200 to 300 bar, whereby by means of novel composition materials, storage pressures of up to 700 bar are targeted.

Related to the storage of hydrogen in pressure tanks, with motor vehicle use, the method for reforming or the like of hydrocarbons, such as, for example, gasoline or diesel, is used already “on board”. In this regard, pressurized hydrogen reservoirs are in use, in particular for improvement of adaptation to load cycle, of the cold start behavior, with breakdowns of the reforming process or the like.

For example, with the mass technical production of hydrogen from hydrocarbons, for example, by steam or auto-heat reforming, the hydrogen primarily stands available at pressures between 20 and 40 bar. By means of multi-stage compressor, the hydrogen is brought subsequently to the storage pressure of approximately 300 bar. This is connected with an energy use of at least 5% of the stored hydrogen. Also, with other methods for pressurizing of the hydrogen to be stored, a corresponding energy use is necessary, so that the total efficiency of the hydrogen use, that is, from the production to use, can be correspondingly reduced.

### SUMMARY OF THE INVENTION

The problem addressed by the present invention is to provide a fuel preparation unit as well as a method for preparing a hydrogen-containing fuel of a fuel energy converter for chemical conversion and energy conversion of the fuel with a fuel pressure reservoir for storing the fuel subjected to pressure, with a higher efficiency of the fuel energy converter compared with known energy converters.

The above problem is resolved with the fuel preparation unit and method of the present invention.

Accordingly, at least one separate pressure energy recycling unit for converting and recycling of pressure energy of the fuel is provided. According to the invention, pressure energy of the hydrogen-containing fuel for preparation of mechanical and/or electrical energy is used, so that in addition to the recycling of the chemical energy of the hydrogen-containing fuel, in addition, its pressure energy can be converted into mechanical and/or electrical energy and correspondingly recycled. This means that at least partially, a recovery of the compression work takes place, which is to be applied for pressurizing of the hydrogen or fuel. In this manner, the system efficiency is increased in an advantageous manner, such that a particularly efficient use of the total energy in the fuel is realized.

Preferably, the pressure energy recycling unit includes at least one mechanical drive device for producing mechanical energy. With the assistance of this element, a conversion of the pressure energy into mechanical energy according to the present invention is achievable in an advantageous manner. The mechanical energy can be used for fulfilling various function s of a fuel cell assembly, a combustion assembly, of a motor vehicle or the like.

In a particular further embodiment of the invention, the pressure energy recycling unit is disposed in the flow between the fuel pressure reservoir and the fuel energy converter. With a corresponding arrangement, the pressure of the fuel pressure reservoir can be reduced or regulated by means of the pressure energy recycling unit, preferably to the operating pressure of the fuel energy converter, such as, for example, the fuel cell unit and/or the combustion device. Simultaneously, the pressure energy of the fuel that is released in this manner, according to the present invention, can be converted and recycled.

Alternatively or in combination to the above, according to an advantageous form of the invention, the pressure energy recycling unit can be disposed in the flow direction downstream of the fuel energy converter. This means that the pressure energy recycling unit on the one hand is exclusively arranged in the flow direction downstream of the fuel energy converter, or on the other hand, in the flow direction downstream as well as in front of the fuel energy converter, in that case, in two separate components.

Through the arrangement downstream of the fuel energy converter, the pressure difference between the operating pressure level of the fuel energy converter and the atmospheric pressure for the pressure energy recovery can be used in an advantageous manner according to the present invention. For example, with a fuel pressure reservoir subjected to a pressure between 200 and 700 bar, the pressure energy in front of the fuel energy converter, through the reduction of the pressure to the operating pressure of the fuel energy converter from approximately 1 to 3 bar by means of a first device and by means of a corresponding second device of the pressure energy recycling unit arranged downstream of the fuel energy converter, the pressure energy of the expansion of this operating pressure to atmospheric pressure can be recovered.

Advantageously, at least one electrical generator for production of electrical energy is disposed on the drive device. In this manner, in an advantageous manner, a production of electrical energy by means of the pressure energy recycling unit according to the present invention can be realized. The electrical energy produced thereby can be used for different purposes. For example, electrical consumer devices of a motor vehicle can at least be partially operated.

Preferably, the pressure energy recycling unit has at least one compressor for compressing a further operating medium of the fuel energy converter. With this embodiment of the invention, the pressure energy of the fuel is recyclable for a further operating medium of the fuel energy converter. A corresponding recycling is advantageous with fuel energy converters, which are operated with an over pressure. This operating pressure, or over pressure, is produced with the assistance of the compressor, according to the present invention, for pressurization of the further operating medium. By means of (partial) compensation of the energy for the pressurization of the further operating medium, the system efficiency of the entire unit can be increased.

In another variant of the invention, the pressure energy recycling unit includes at least one coupling device for coupling the drive device with the compressor. For example, the coupling device is realized as an electrical connection, by which the generator of the drive device, in particular for electrical supply of the compressor, is adjustable.

Alternatively, or in combination to the above variant, the coupling device is formed with at least one shaft of the like. A mechanical coupling device permits a particularly trouble-free and comparatively simple to realize coupling. In this connection, in particular, a so-called charge of the further operating medium, such as air or the like by means of the pressure energy of the fuel, can take place.

Advantageously, the coupling device has at least one gear unit for mechanically adapting the compressor to the drive device. With the assistance of a corresponding gear unit, in particular, a mechanical translation, that is, adaptation of the rotational speed, between the drive unit and the compressor can be converted. In particular, this can be advantageous with direct mechanical coupling of the two components owing to the most possible, very different mass flow with which the fuel expansion and the compression of the further operating medium.

In a preferred manner, an electric, supplementary drive of the compressor is arranged, advantageously by means of a free-running switching operation of the coupling device, or a corresponding shaft, upon insufficient expansion work of the fuel, for permitting a power compensating weight on the coupling device.

Generally, the pressure energy recycling unit can include screw compressors, spiral compressors, and/or blade compressors, or turbines, or the like for expansion or compression of the fuel or of the further operating medium, such as air or the like. If necessary, commercially sized components can be relied on, wherein a particularly economically advantageous embodiment of the invention can be realized.

Preferably, at least in the flow direction upstream of the fuel energy converter, a separate pressure reducing element for limiting the fuel pressure is disposed. For example, the reduction of the pressure of the fuel pressure reservoir takes place from the storage pressure to the operating pressure of the fuel energy converter, in particular, the fuel cell unit or the combustion device, preferably with the assistance of a pressure reducing valve or the like. A corresponding separate pressure reducing element makes possible an especially exact and relatively simple to be adjusted regulation or reduction of the fuel pressure to the operating pressure of the fuel energy converter. By means of the comparatively reliable reduction of the storage pressure to the operating pressure by means of the separate pressure reduction elements, the margin of safety of the fuel preparation upon problems of the pressure energy recycling unit or the like is decidedly increased.

Generally, the pressure energy recycling unit is realized as a one-stage unit; that is, the storage pressure is merely reduced in one method stage to the operating pressure. Alternatively, however, in particular use situations, also a multi-stage reduction of the storage pressure to the operating pressure can be realized. With this last variant of the invention, many consecutively actuated expansion stages are provided.

Fundamentally, by means of a corresponding heating unit, or a heat exchanger, too large of a cooling of the fuel in the pressure energy recycling unit, or in the single stage of the recycling unit, can be advantageously prevented. A heat exchange that is provided in this case is formed in an advantageous manner such that it uses the heat of the fuel cell unit, the combustion, and/or other heat-producing components, such as, for example, the reformer or the like, for heating of the fuel.

### BRIEF DESCRIPTION OF THE DRAWINGS

FIG. 1 shows a schematic block diagram of one embodiment of the present invention with a fuel cell; and

FIG. 2 shows a schematic block diagram of a further embodiment of the present invention with a combustion engine.

### DETAILED DESCRIPTION OF THE PREFERRED EMBODIMENTS

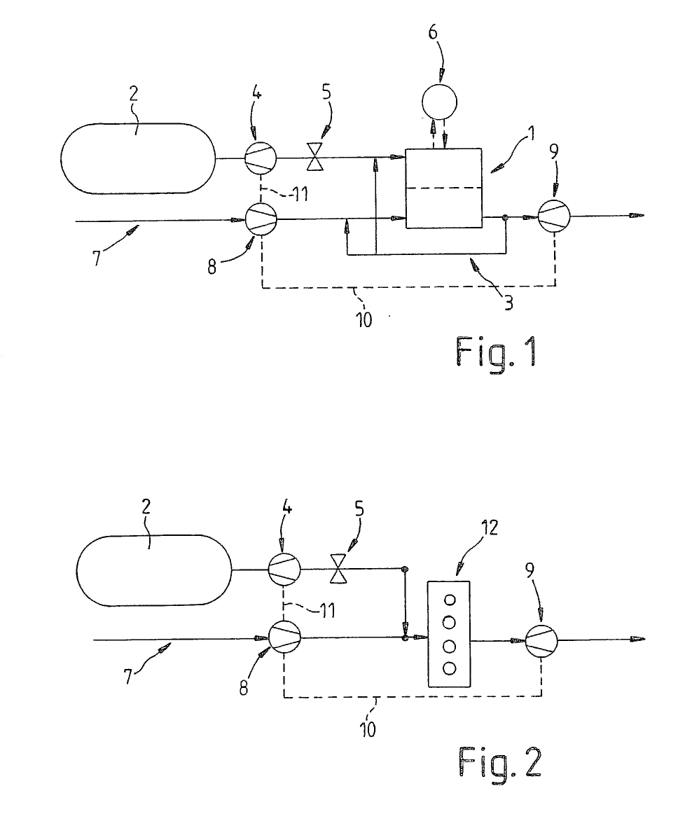

In FIG. 1, a fuel cell assembly with a fuel cell 1, or a fuel cell stack 1 and a pressure reservoir 2 for storing of pressurized hydrogen is illustrated. For example, the fuel cell 1 operates as a PEM fuel cell 1, which is supplied on the anode side with hydrogen from the pressure reservoir 2.

By means of the electrochemical reaction of the hydrogen and oxygen, hydrogen-rich air flow exists on the cathode side. For a neutral water balance, that is water must not be refueled as operating material, the existing, out-flowing water 3 is again condensed out and remains available for humidification of the membrane.

According to the invention, the reduction of the storage pressure of the storage reservoir 2 takes place to the operating pressure of the fuel cell 1 with the help of a turbine 4 and by means of the pressure reducing valve 5, which is optional.

The electrical flow of current produced in the fuel cell 1 is converted in particular with an electric motor 6 in drive energy for a motor vehicle (not specifically shown).

According to FIG. 1, the operating material air 7 is raised by means of a compressor 8 to the operating pressure of the fuel cell 1. For example, this can be raised about 3 bar. Generally, the fuel cell 1 also can be operated with an ambient pressure of 1 bar. In this case, a comparatively simple ventilator 8 or the like suffices as a variant for the compressor 8.

The operation of a fuel cell 1 under increased pressure of approximately 3 bar yields in an advantageous manner higher fuel cell efficiency and permits sufficient water 3 for humidification from the process to condense out. With the help of a turbine 9 connected to the fuel cell 1, additionally a part of the compression work of the compressor 8 can be re-obtained by means of the expansion of the operating pressure to the atmospheric pressure.

Depending on the respective use situation, or the provided pressures, can a coupling 10 or 11 (represented in dotted line) can be provided between the turbine 4, the compressor 8 or the ventilator 8 and/or the turbine 9. The turbine 9 falls 1 bar with an operating pressure of the fuel cell 1.

Preferably, the coupling 10 and/or 11 is realized mechanically, in particular by means of a shaft. This means that the compressor 8 and the turbines 4 or 9 are disposed on a shaft in this case. In particular, for permitting a power compensating weight, an electrical supplementary drive of the compressor 8 on the mechanical coupling 10, 11 (not shown), upon insufficient expansion work, is possible by means of a free-running of the shaft. However, also a complete mechanical decoupling of the components 4, 8, 9 is realizable, according to the present invention. In this regard, an electrically driven compressor 8 as well as the recovery or coupling of the expansion work in the turbines 4, 9 via a not shown generator by means of electrical energy is contemplated.

Based on the differing pressure levels upon the expansion, in particular, from 300 bar to 3 bar and the compression, above all from 1 bar to 3 bar, and the relatively narrow mass flow of hydrogen from the pressure reservoir 2, many, not specifically illustrated, serially actuated expansion stages are also contemplated.

With a direct, mechanical coupling 11 of the turbine 4 and compressor 8, a mechanical translation, that is, adaptation of the rotational speed, between the compressor 8 and the turbine 4 or 9 is advantageous in view of the different mass flows from the hydrogen expansion.

In a non-illustrated manner, with a multi-stage expansion of the hydrogen, an intermediate heating of the hydrogen gas to be supplied to the fuel cell 1, in particular, by means of a heat exchanger for use of the heat of the fuel cell 1, is contemplated.

The valve 5 itself permits with a problem or unordinary manner of operation of the turbine 4 a reliable reduction of the storage pressure to the operating pressure of the fuel cell 1, so that corresponding disadvantageous affects can be avoided.

In FIG. 2, a further embodiment of the invention with a combustion engine 12 is illustrated. The combustion engine 12 requires for its operation hydrogen as well as air 7. Similar or comparable components of FIGS. 1 and 2 are identified with the same reference numerals.

According to FIG. 2, hydrogen is supplied by means of the turbine 4 as well as the valve 5 from the pressure reservoir 2 to the lifting cylinder engine 12 and burned together with air 7. A charge of the air 7 is realized by means of the turbine 9, or the compressor 8, and leads to a particularly clean combustion and to a relatively minimal fuel usage. This charge can be supported or realized in this case by means of the coupling 11 with the turbine 4.

According to the invention, the expansion work of the hydrogen stored in the pressure reservoir 2 is made useable by means of the turbine 4. In addition, a mechanical and/or electrical coupling 10, 11 of the components 4, 8, 9 according to FIG. 1 can be realized accordingly.

It will be understood that each of the elements described above, or two or more together, may also find a useful application in other types of constructions differing from the types described above.

While the invention has been illustrated and described herein as a fuel preparation unit and method for preparing a fuel containing hydrogen, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A fuel preparation unit for furnishing a fuel that contains hydrogen to a fuel energy converter (1, 12) for chemical conversion and energy conversion of the fuel, having a fuel pressure reservoir (2) for storing the fuel subjected to pressure, characterized in that at least one separate pressure energy recycling unit (4, 8, 9) is provided for converting and recycling pressure energy of the fuel.

2. The unit of claim 1, wherein the at least one pressure energy recycling unit (4, 8, 9) includes at least one mechanical drive device for generating mechanical energy.

3. The unit of claim 1, wherein the at least one pressure energy recycling unit (4, 8, 9) is disposed in the flow between the fuel pressure reservoir (2) and the fuel energy converter (1, 12).

4. The unit of claim 1, wherein the at least one pressure energy recycling unit (4, 8, 9) is disposed in the flow direction downstream of the fuel energy converter (1, 12).

5. The unit of claim 2, wherein at least one electrical generator for generating electrical energy is disposed on the at least one mechanical drive device.

6. The unit of claim 1, wherein the at least one pressure energy recycling unit (4, 8, 9) has at least one compressor (8) for compressing a further operating medium (7) of the fuel energy converter (1, 12).

7. The unit of claim 6, wherein the at least one pressure energy recycling unit (4, 8, 9) includes at least one coupling device (10, 11) for coupling a drive device to the at least one compressor (8).

8. The unit of claim 7, wherein the at least one coupling device is a mechanical coupling device (10, 11).

9. The unit of claim 7, wherein the at least one coupling device (10, 11) has at least one gear unit for mechanically adapting the compressor (8) to a drive device.

10. The unit of claim 1, wherein at least in the flow direction upstream of the fuel energy converter (1, 12), a separate pressure reducing element (5) for limiting the fuel pressure is disposed.

11. A fuel cell assembly, having a fuel preparation unit for furnishing a fuel that contains hydrogen, having a fuel pressure reservoir (2) for storing the hydrogen-containing fuel subjected to pressure, and having a fuel cell unit (1) as a fuel energy converter (1, 12) for chemical conversion and energy conversion of the fuel, characterized in that the fuel preparation unit is embodied in accordance with claim 1.

12. A combustion system, having a fuel preparation unit for furnishing a fuel that contains hydrogen, having a fuel pressure reservoir (2) for storing the hydrogen-containing fuel subjected to pressure, and having a combustion system (12), in particular an internal combustion engine (12), as a fuel energy converter (1, 12) for chemical conversion and energy conversion of the fuel, characterized in that the fuel preparation unit is embodied in accordance with claim 1.

13. A vehicle having a fuel preparation unit for furnishing a fuel that contains hydrogen, having a fuel pressure reservoir (2) for storing the hydrogen-containing fuel subjected to pressure, and having a fuel cell unit (1) and/or a combustion system (12), in particular an internal combustion engine (12), as a fuel energy converter (1, 12) for chemical conversion and energy conversion of the fuel, characterized in that the fuel preparation unit is embodied in accordance with claim 1.

14. A method for furnishing a fuel containing hydrogen to a fuel cell unit (1) and/or to a combustion system (12), in particular an internal combustion engine (12), as a fuel energy converter (1, 12) for chemical conversion and energy conversion of the fuel, having a fuel preparation unit and a fuel pressure reservoir (2) for storing the hydrogen-containing fuel subjected to pressure, characterized in that pressure energy of the hydrogen-containing fuel is used to furnish mechanical and/or electrical energy.

15. The method of claim 14, wherein a fuel preparation unit in accordance with claim 1 is used.
